(19) United States
(12) Patent Application Publication
(10) Pub. No.: US 2013/0250344 A1
(43) Pub. Date: Sep. 26, 2013

(54) METHOD, SYSTEM AND APPARATUS FOR A GRAPHICAL CUSTOM ORDER WITH AN INTERACTIVE VIRTUAL REPRESENTATION FOR FEATURE SELECTION

(71) Applicants: Ray Uri Merriam, Rochester, NY (US); Matthew Frederick Hoffmann, Ontario, NY (US); Michael Charles Blowers, Fairport, NY (US); Joel Eric Colletti, Canandaigua, NY (US)

(72) Inventors: Ray Uri Merriam, Rochester, NY (US); Matthew Frederick Hoffmann, Ontario, NY (US); Michael Charles Blowers, Fairport, NY (US); Joel Eric Colletti, Canandaigua, NY (US)

(73) Assignee: XEROX CORPORATION, Norwalk, CT (US)

(21) Appl. No.: 13/424,508

(22) Filed: Mar. 20, 2012

(51) Int. Cl. G06K 15/02

(52) U.S. Cl. 358/1.15

(57) ABSTRACT

A computer implemented system and interactive method for selecting finishing options for a print job are disclosed. The method includes receiving a print job which includes a document to be printed and associated job ticket information. Finishing options available are displayed using an interactive virtual representation of the document as it will be printed and a visualization of the document as it would be rendered with a user selected finishing option(s).

### CROSS REFERENCE TO RELATED PATENTS AND APPLICATIONS

U.S. patent application Ser. No. 12/393,371 to Hoppenot et al., filed Feb. 26, 2009 and entitled “SYSTEM FOR VISUALLY MANAGING OFFICE DOCUMENT FINISHING OPTIONS”, is incorporated herein by reference in its entirety.

### BACKGROUND

This disclosure relates to a system and method for pre-print job visualization that enables users to view a virtual representation of a printed job which incorporates printer-specific finishing options.

Managing finishing options like stapling, folding, or imposition is not always an easy task for office users. The lack of knowledge about office printer options, in general, and of those actually available on a given printer, and how these options will be applied on the final document can lead users to print one or several drafts prior to obtaining the intended result.

Systems have been developed for document production visualization which provide a virtual rendering of the document being described in job definition format (JDF) or similar standardized input. This virtual rendering has the advantage of being able to “see” and manipulate in 3D, the document before time and materials are committed to the production process. The document can be viewed, as it should appear in a final, finished form, or at any stage of a production process.

### INCORPORATION BY REFERENCE

U.S. patent application Ser. No. 12/163,219, filed Jun. 27, 2008, by Pouyadou et al. and entitled “A DYNAMIC XPS FILTER”;

U.S. Pat. No. 5,845,263 by Camaisa et al., issued Dec. 1, 1998, and entitled “INTERACTIVE VISUAL ORDERING SYSTEM,” and

U.S. Patent Application Publication No. 2010-0214598-A1 to Hoppenot et al., published Aug. 26, 2010 and entitled SYSTEM FOR VISUALLY MANAGING OFFICE DOCUMENT FINISHING OPTIONS, are incorporated herein by reference in their entirety.

### BRIEF DESCRIPTION

In one embodiment of this disclosure, described is a computer implemented interactive method for selecting job ticket options for a print job comprising a) a computer receiving a print job including a document including one or more pages to be printed, and an associated user configurable job ticket including user selectable job ticket options; b) simultaneously displaying a virtual representation of one or more pages of the document associated with the print job as a finished product and an interactive user interface on a graphical user interface, the virtual representation including document borders associated with the edges of the one or more pages of the document to be printed, the interactive user interface displaying within the document borders and/or on one or more borders and/or substantially near one or more border's one or more user configurable features associated with the print job; and c) receiving a user input associated with a configurable feature to modify the job ticket and updating the virtual representation of the print job to reflect the received user input associated with the configurable feature.

In another embodiment of this disclosure, described is a printing system user interface comprising a graphical user interface configured to display a virtual representation of a print job including a document to be produced, and, simultaneously, to display an interactive user interface, the virtual representation including document borders associated with the edges of one or more pages associated with the document to be produced, the interactive user interface displaying within the document borders and/or on one or more borders and/or substantially near one or more borders, one or more user configurable features associated with the print job.

In still another embodiment of this disclosure, described is a web-based printing system comprising a web-based graphical user interface; a user work station operatively connected to the web-based graphical user interface via the internet; and a print shop operatively connected to the web-based graphical user interface, wherein the graphical user interface is configured to communicate with the user work station, and the graphical user interface is configured to display a virtual representation of a print job including a document to be produced by the print shop, and simultaneously, to display an interactive user interface, the virtual representation including document borders associated with the edges of one or more document pages associated with the document to be produced, the interactive user interface displaying within the document's borders and/or substantially near one or more borders, one or more user configurable features associated with the print job.

### BRIEF DESCRIPTION OF THE DRAWINGS

FIG. 1 is a schematic view of an exemplary environment in which a pre-print job interactive virtual representation system operates in accordance with an exemplary embodiment of this disclosure.

FIG. 2 is a schematic view of a print path according to an exemplary embodiment of this disclosure.

FIG. 3 is a flow chart of an interactive virtual representation process according to an exemplary embodiment of this disclosure.

FIGS. 4-7 are screen shots of an interactive virtual representation of an imported document associated with a print job according to an exemplary embodiment of this disclosure, including binding options.

FIGS. 8-10 are screen shots of an interactive virtual representation of an imported document associated with a print job according to an exemplary embodiment of this disclosure, including hole creation options.

FIGS. 11-13 are screen shots of an interactive virtual representation of an imported document associated with a print job according to an exemplary embodiment of this disclosure, including paper color options.

FIGS. 14-16 are screen shots of an interactive virtual representation of an imported document associated with a print job according to an exemplary embodiment of this disclosure, including staple options.

### DETAILED DESCRIPTION

As briefly discussed in the background, the conventional job ticket can be a custom job order system, for example XJT (Xerox Job Ticket). There are a lot of settings and ways to configure these custom orders. For most users, there are more settings than they can understand or use and this complexity of the User Interface can actually discourage users from using the system. Needed is a method, system and/or apparatus to make it easier and faster for users to create a custom job order associated with a print job.

Provided is an interactive apparatus that can be used to present to an end user an interactive virtual representation of a product that they want to order with the ability to see other or alternate features that are selectable by the user. The system presents a virtual representation of the finished product. In conjunction, it interactively presents additional features that the user can add and/or modify. As the user adds or selects new features, the virtual representation is updated to show those new features. Furthermore, the user is able to interact with the virtual representation, allowing for customization of the product without having to look away from the virtual representation. In addition, the user is able to remove features from the virtual representation.

The system is also able to determine which additional features are available to the end user based on current features. And if needed, the system groups similar features into categories. If a feature is selected by the user that can't be used at the same time as one that is already selected, the system will automatically disable the currently enabled feature before it is enabled and displayed. As the user modifies the visual selection interface, the system records the selected features which the user has updated and/or removed.

Some job ticket applications, such as XJT, already include a user interface that allows a user to upload a document or specify where to obtain the document that the user wants used or printed. They may also allow a user to use buttons, check boxes and dropdown menus, providing the ability to specify how the user wants the document printed and finished. However, as previously discussed, all of the buttons, check boxes and dropdown menus can be confusing and daunting. So, to make the interface/application more intuitive for a user, this disclosure provides an interactive virtual representation of the print job, including features which are selectable by the user.

According to an exemplary embodiment of this disclosure, provided is a computer implemented interactive method for selecting job ticket options for a print job, the method first displaying the user's custom job (finished product) visually. This is a visual or virtual representation of how the custom job or product will look after the customization is complete. Initially, there is nothing to display until the user has selected a document source or uploaded a document. Once the document is selected or uploaded, a virtual representation of the job is displayed based on this document.

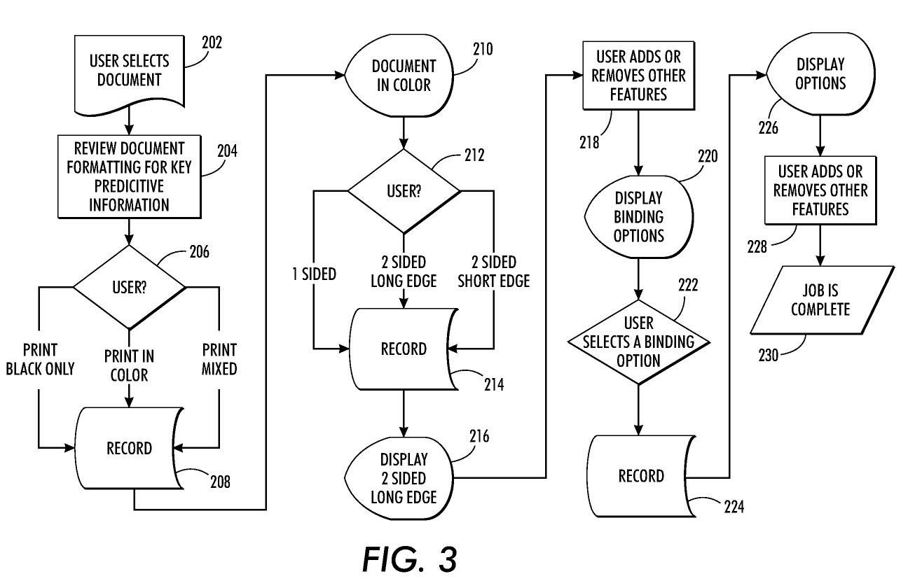

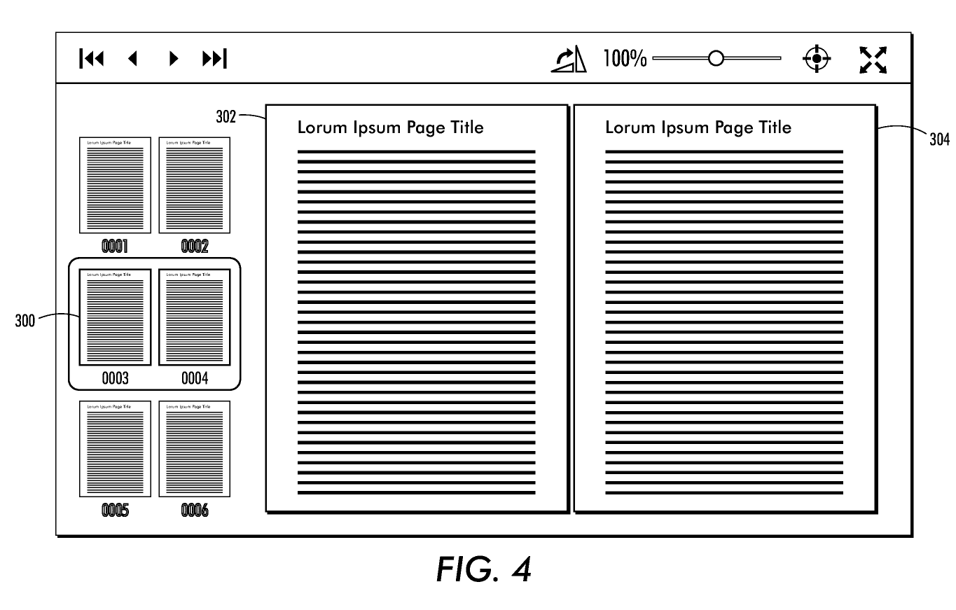

Next, the user is presented with a choice of options that can be applied to the job. According to an exemplary embodiment, this presentation includes images substantially on or near one or more of the borders of the visual display and/or it can be presented within the visual display of the virtual representation (see FIGS. 4-16). In addition, the visual display guides the user through the process of selecting job ticket options for a print job associated with the document (see FIG. 3). These options may include, but are not limited to, options related to printing in mono, color or mixed; collation; print side, i.e. duplex/simplex; orientation, i.e. portrait/landscape; body media type such as white or colored paper, card stock, transparency, letterhead; stapling; binding, such as coil, comb, tape, O and D ringed binder, velobind hard cover back; hole punching/drilling; folding; cutting; scoring; lamination; tabs; and cover type/media.

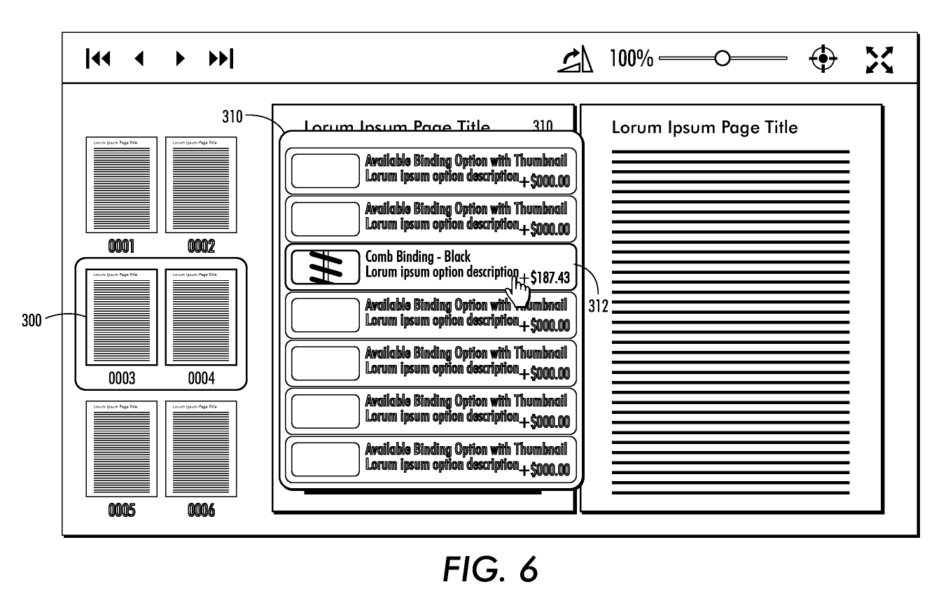

For example, the user can see that they can add a binding option to their print job and if the user wants to select a binding type, they are presented with a list of binding options (see FIG. 6). For some of the options, the choices may be so numerous that the user is presented with a second set of options after selecting the first. This allows the user to interactively customize their job without requiring them to look away to a different part of the screen by providing a visualization of the options that is interactive. For example, the user selects staple as the binding, but the user does not like where the staple is placed based on the visual representation of the print job with the included staple. The interactive visualization allows the user to move the staple. For example, from the top left to the top right corner.

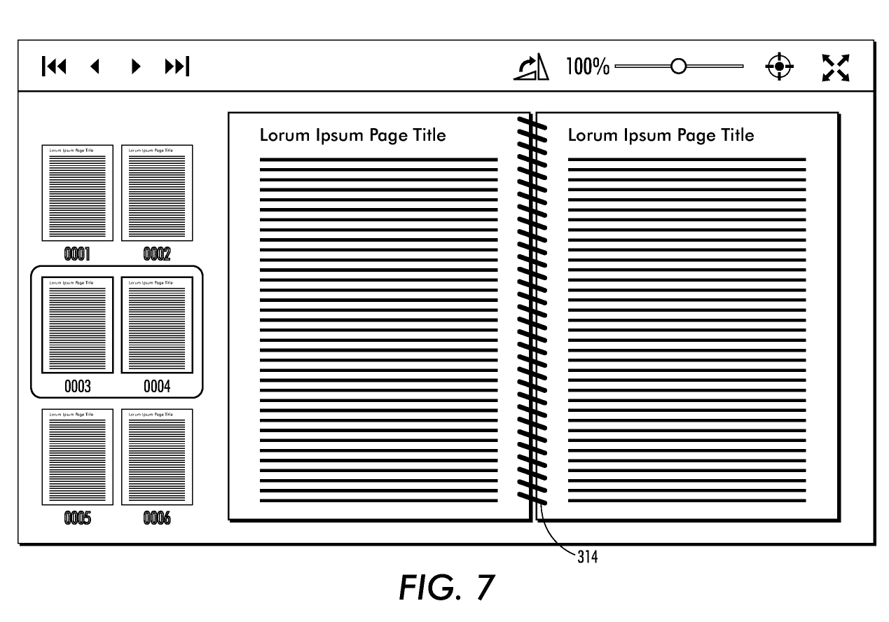

As the user selects the feature they want, the virtual representation is updated to display the print job with that feature (see FIG. 7). If the user does not like the option that was selected, they may select a different feature or remove a selected feature all together.

After the user is finished with the customization of their print job, they may submit the order for processing and printing.

Within a job ticket application, many features can typically be selected by a user. It is to be understood that this disclosure, and the exemplary embodiments disclosed herein, are not limited to a specific feature, as those will vary by the type of product and/or on what prior features have already been selected.

Some benefits according to the exemplary embodiments disclosed herein include:

The visual (virtual) representation of a print job or product.

The ability to visually see options, features or parts that can be added to a print job or product.

The ability to interact with the visual representation of the print job or product, providing customization in a very intuitive manner.

The ability to add options, features or parts to a print job or product and the user to see the visual (virtual) representation updated to incorporate the added features.

The net effect of providing an interactive virtual representation is to make it a lot easier for an average user to order a print job or product such that it meets their exact specifications. This will enable the process of ordering a custom print job or product faster, easier, and more accurate. There will be fewer print jobs or products that fail to meet the customer's expectations resulting in less waste and cost. Furthermore, users are more willing to use the on-line method of ordering a custom job a second and third time and fewer steps are involved with modification of a print job due to the interactive virtual representation resulting in a faster turnaround time.

While this disclosure, and the exemplary embodiments described herein, specifically provide a method, system and apparatus for a graphical custom order, including an interactive virtual representation for feature selections associated with a print job, it is to be understood that this disclosure is not limited to a print job. For example, an interactive virtual representation interface, as disclosed herein, can be utilized with any product which can be ordered by a user and the product can be customized by the user. For example, but not limited to, food orders, automobile orders, parts orders, etc.

Furthermore, the disclosed embodiments are not limited to a specific visual platform and/or job ticket format. For example, visual platforms based on flash, HTML, or Silverlight can be utilized for various job ticket formats, for example, but not limited to, XJT.

The following detailed description, along with the attached figures, provides additional details associated with an interactive virtual representation of a print job, according to an exemplary embodiment of this disclosure. Specifically, the exemplary embodiment provides a system, method, and apparatus which provides for interactive selection of finishing options for a print job which is yet to be rendered by any one of a set of office printers through use of an interactive virtual representation of the print job.

A “print job,” as used herein, includes a document to be printed, which may include one or more related sheets or electronic document page images, received from a particular user, or otherwise related, as well as a print job ticket comprising information on how the job is to be printed (e.g., page size, paper type, printer, and finishing requirements). Each page image generally may include information in electronic form which is to be rendered on the print media by the printer and may include text, graphics, pictures, and the like. A “finisher” can be any post-printing accessory device of a printer, such as a collator, sorter, mailbox, inserter, interposer, folder, stapler, stacker, hole puncher, stitcher, binder, envelope stuffer, postage machine, or the like. Each printer may have only a selected subset of possible finishing capabilities provided by selected ones of these finishing devices, this limiting the finishing options which each printer can provide. The operation of applying images to print media, for example, graphics, text, photographs, etc., is generally referred to herein as printing.

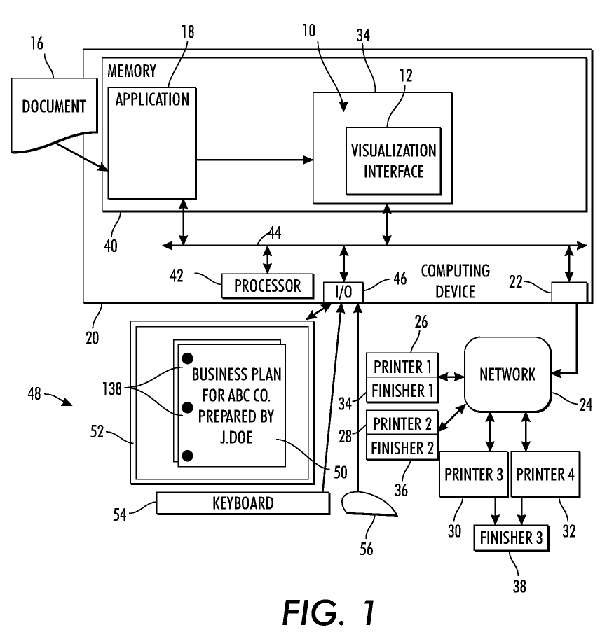

With reference to FIG. 1, an exemplary computer implemented pre-print job visualization system 10, for generating a virtual representation of a document prior to printing, is shown in an operating environment, an office network printing system or a remote on-line print shop environment. The visualization system 10 includes a pre-print job visualization interface 12, which in the exemplary embodiment is an add-on component to a print driver. Users of the exemplary system 10 create documents 16 for printing using a document processing application 18, such as a word processing program or image processing program. The application 18 may be hosted by the user's computing device 20, e.g., a personal computer, laptop computer or any other computing device hosting or accessing the print driver. Alternatively, the computing device 20 resides on a cloud network and/or a computing device located at a print shop, whereby a user accesses the computing device, i.e. server, over the internet. A network interface 22 of the user's computer 20 provides a wired or wireless link between the print driver and a printing network 24. Network 24 may link several office computing devices including computing device 20, to a plurality of networked printers 26, 28, 30, 32 (here illustrated as printer 1, printer 2, printer 3, and printer 4). Here, “network” is used loosely to encompass all printers that the print job can be directed to for printing. The printers are each associated with finishers 34, 36, 38. Each printer may have its own finisher which provides one or more finishing capabilities (as illustrated for printers 1 and 2), and/or some printers may share the same finisher (as illustrated for printers 3 and 4). Thus, different finishing capabilities may be available to the user on the network. While four printers and three finishers are illustrated, it is to be appreciated that there may be fewer or more printers and finishers, such as 2, 3, 4, 5, or more.

The interactive visualization interface 12 and exemplary print driver may form a part of a spooler 34, which controls the placement of print jobs in a print queue or their submissions to a print shop over the network 24, which could be the internet. In some embodiments, where the print driver is not compatible with one or more of the printers 26, 28, 30, 32, the print driver interfaces with one or more additional print drivers, each specific to a particular type of printer, for converting the print-ready document into a format accepted by the specific printer.

As will be appreciated, the components of the system 10, such as driver, visualization interface 12, and spooler 34 may be embodied in hardware or software. In the exemplary embodiment, these components are software components stored in memory 40 of computing device 20, and which are implemented by a processor 42, such as the computer's CPU, which is communicatively linked with memory 40, e.g., via a bus 44. The memory 40 may represent any type of computer readable medium such as random access memory (RAM), read only memory (ROM), magnetic disk or tape, optical disk, flash memory, holographic memory, or combination thereof. However, it is to be appreciated that the various components may be hosted by more than one communicatively linked computing device. The computing device 20 is communicatively linked by an input/output device 46 to a graphical user interface (GUI) 48 for displaying an interactive three-dimensional visualization 50, which is a representation of the document as it would be printed, generated by the visualization interface 12.

The exemplary GUI 48 includes a display screen 52, on which the interactive virtual representation is displayed, such as a computer monitor or laptop screen, and one or more user input devices for manipulating the representation 50, here illustrated as a keyboard 54 and cursor control device 56, such as mouse, trackball, or the like, although it is to be appreciated that other input devices, such as a keypad, touch or writable screen, joystick, haptic device, or the like may alternatively or additionally be employed as the user input device.

In the exemplary embodiment, each of the printers 26, 28, 30, 32 has a set of finishing capabilities provided by the printer's finisher, such as stapling, book binding, hole punching, collating, sorting, mailbox labeling, folding, stacking, stitching, binding, envelope stuffing, postage application, and the like. The finishing capabilities of the printers may not be identical and may vary over time as finishing components of the printers are added, replaced, removed, modified, or temporarily go offline. Additionally, each printer may vary with respect to a single finishing capability, such as whether there is the capability for stapling documents which have a large number of pages, where the staple can be positioned on the printed document, where the hole-puncher places the holes with respect to the margins of the page, and so forth. Further, some printers may have different rendering capabilities, such as black only (monochrome), multi-color printing (such as cyan, magenta, yellow and black), which is referred to herein simply as color printing, and the like. Printers may be stacked with different grades of print media, such as heavyweight paper, lightweight paper, preprinted paper, transparent sheets, and the like.

The exemplary print job interactive visualization system 10 extends the capabilities of the print driver by providing a printer-specific what-you-see-is-what-you-get (WYSIWYG) interface 12 which is able to display and interact with a document preview 50 presented to the user on the display screen 52 of the GUI 48. Rendered finishing options are linked to the capabilities of the available printers. Thus, content of the preview 50, displayed during interactive editing, appears as the final output will appear. Generally, a printed document is illustrated, as shown in FIGS. 4-16. For example, a color print job is shown in color if color printing capability is available and selected, or in black and white if not; a monochrome job is shown in black and white. Staples, sides, hole-punches, and the like are also represented as an interactive virtual representation.

The print job visualization system 10 is capable of identifying the current finishing and rendering capabilities of the available printers 26, 28, 30, 32, etc. Additionally, based on the available printers, the system 10 identifies the printer's capabilities and generates an interactive virtual representation 50 of a user provided document as it would be output by one or more printers, given the finishing capabilities of the printers which are selected by the user.

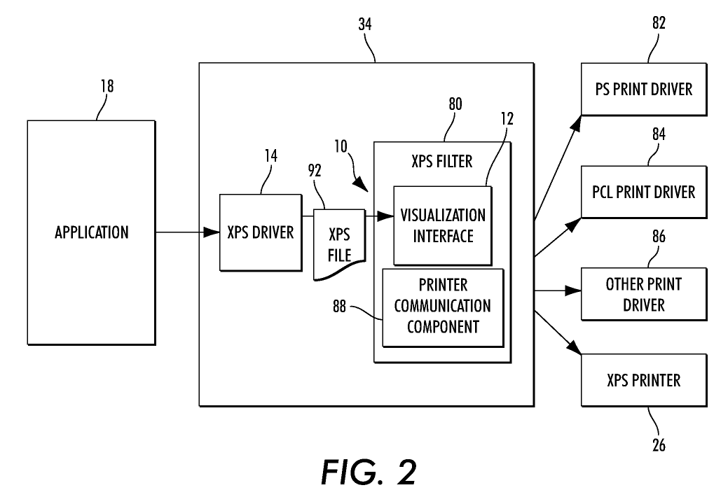

In operation, an electronic document 16 which is to be printed in the office/print shop environment is sent, as normal, from the application 18 to the print driver, e.g., when the user clicks on file-print in a print user interface. Next, a window showing an interactive virtual representation 50 of the printed document is displayed to the user. As a virtual object, the user can virtually turn the rendered document in order to see all finishing and rendering options such as duplex or simplex, staples, holes 138, or N-up imposition which are made available by the available printer's finishing capabilities. The user can also virtually turn the pages of the document. As illustrated in FIG. 2, the user can interact with these finishing options by selecting an available option which is interactively displayed. The system 10 provides a representation of available finishing options displayed within the virtual representation of the print job, and the user can then select one or more of the available finishing option(s). As the user selects finishing options, the virtual rendering aspects of the document change. Also, the user can validate or cancel the print job at any time, for example, by clicking on the displayed OK or cancel buttons. Validating the print job causes the driver to update the print job and send it to the appropriate printer with the selected finishing options.

FIG. 2 illustrates, by way of example, an embodiment of the system 10 utilizing an XPS print path 14. XPS is the XML Paper Specification, which defines an open document format that uses extensible mark-up language XML. It is to be appreciated that other document formats may be used. The XPS print path allows the usage of filters at the spool time. These filters give the opportunity to deal with the rendered version of the document in XPS format and the settings set by the user during the print action. The exemplary visualization interface 12 then functions as one of the filters 80 of the XPS print path, facilitating ease of installation as an add-on component. For further details of XPS filters see, for example, U.S. patent application Ser. No. 12/163,219, filed on Jun. 27, 2008, entitled “A DYNAMIC XPS FILTER,” by Jerome Pouyadou, et al., the disclosure of which is incorporated herein by reference in its entirety. Each filter in the XPS print path may be binary so that when filter 80 is ON, the system automatically calls up the visualization interface 12. If the filter is switched off, the visualization interface 12 is bypassed.

Some printers (e.g., Printer 1) are directly compatible with the XPS format. For other printers, the XPS file 92 can be easily converted to another page description language, such as PostScript (PS) or PCL, using, for example, a universal print driver which is capable of converting the file to an appropriate one of a set of page description languages. Or, as shown in FIG. 2, a separate print driver 82, 84, 86, etc. may be provided for each printer format.

As illustrated in FIG. 2, a printer communication component 88 is configured for broadcasting the printers 26, 28, 30, 32, etc. on the network to identify the capability of the printers for rendering the print job. As a user selects finishing features, the visualization interface updates the job ticket to reflect any changes the user has made. As will be appreciated, two or more of components may be combined into a single component. In the exemplary embodiment, component 88 is a software component that may form a part of the XPS filter 80, although in other embodiments, they may be add-on components to the visualization interface 12 or print driver.

With reference to FIG. 3, illustrated is a flow chart of a computer implemented interactive method for selecting job ticket options for a print job according to an exemplary embodiment of this disclosure. According to this embodiment, a user communicates with an on-line print shop over the internet, whereby the user logs on to a web server which includes the software required to generate a print job ticket customized to the user's requirements via an interactive virtual representation.

Initially, at step 202, after the user is logged onto the system, the user selects or uploads a specific document to be printed, which is communicated to the server.

Next, at step 204, the server application processes the document formatting for key predictive information.

Next, at step 206, the user's computer display/GUI, the server application prompts the user to select black printing, color printing or mixed printing, and the server application records this user selection at step 208.

Step 210 indicates, in this example, the user has selected color printing.

Next, at step 212, the server application prompts the user to select one sided printing, two sided long edge printing or two sided short edge printing, and the server application records this user selection at step 214, which in this case is 2 sided long edge.

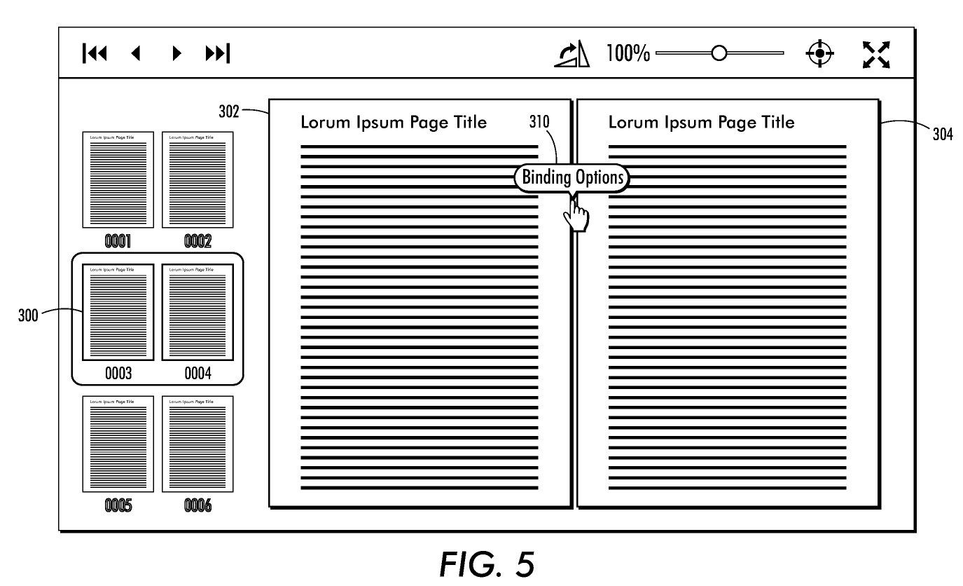

At this point, step 216, the server application displays an interactive virtual representation of the document in color using a two sided long edge format, as if a book may be formatted. For example, FIG. 4 shows a virtual representation of a document according to this format, the document including a series of pages, 0001-0006, whereby the user has selected view 300, including page 0003 and 0004, which corresponds to view 302 and 304. As shown in FIG. 5, the interactive virtual representations of the document includes configurable finishing options, i.e. binding options 310, which are displayed within the edges of the pages of the viewed document and/or substantially near one or more borders of the viewed document, whereby a user is not required to go to a different view to select a finishing option. As shown in FIG. 5, the user simply scrolls over the document view with a mouse to view what finishing options are available. Alternatively, all finishing options can be viewable as a superimposed overlay.

At step 218, the user adds or removes features which are displayed. For the illustrated example, the user selects binding options by mouse clicking text bar/icon 310 of FIG. 5. However, other displayed icons could be associated with, but not limited to, stapling, hole punching, folding, cutting, scoring, cover type, cover color, media type, etc.

At step 220, the server application displays the binding options available to the user, for example, as illustrated in FIG. 6, where the user has selected, at step 222, binding-black 312.

Next, at steps 224 and 226, respectively, the server application records the user binding selection and displays the document with a comb binding 314, as selected, and illustrated in FIG. 7. Notably, the user was not required to look at a different view to select a binding option.

At step 228, the user modifies selections, adds other finishing selections and/or removes other finishing options, until the user is satisfied with the virtual representation of the print job.

Finally, at step 230, the customized job ticket is completed and submitted for execution.

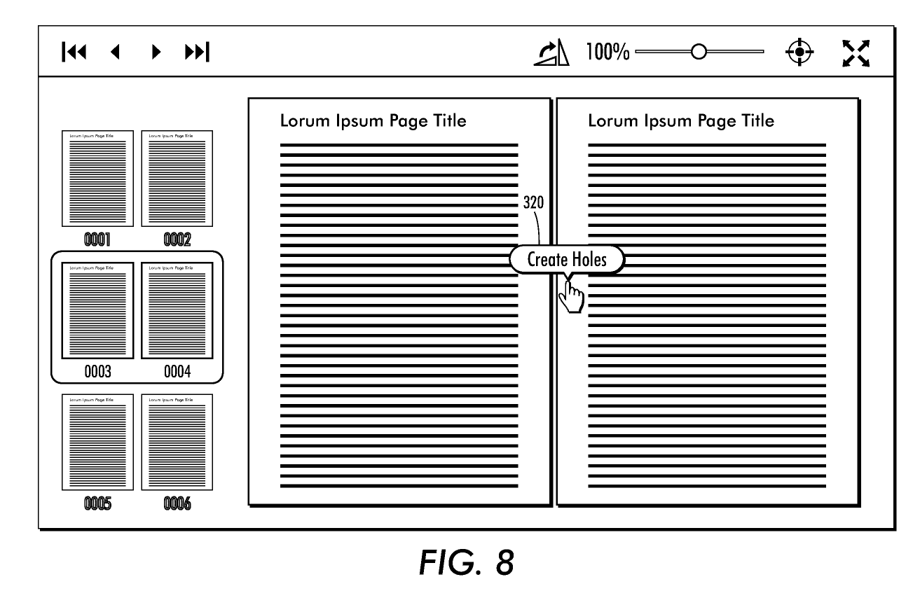

With reference to FIGS. 8-10, illustrated are the interactive virtual representation displays associated with the user configured feature of hole creation. Here, as in step 228 of FIG. 3, the user places the mouse curser in the vicinity of where a hole is desired and the interactive virtual representation displays an icon/text box labeled “create holes” 320, as shown in FIG. 8.

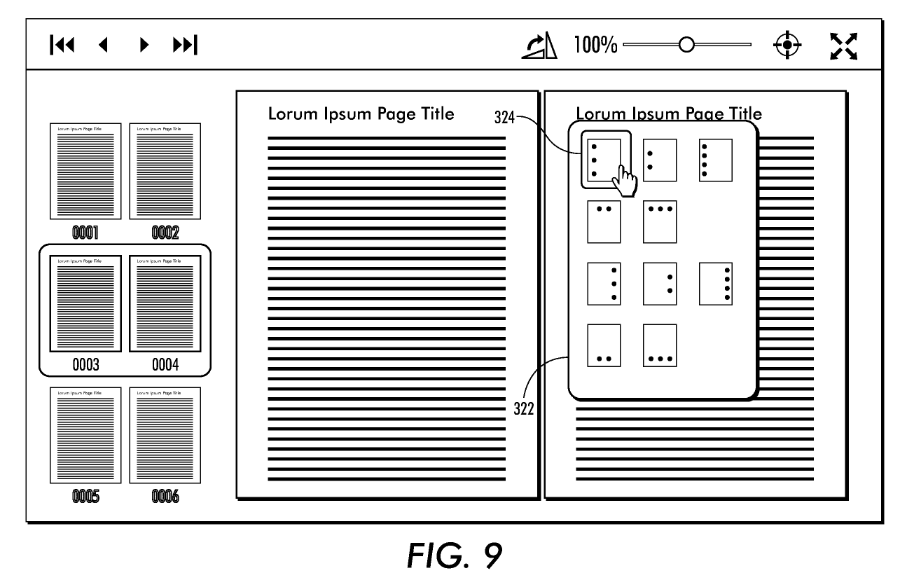

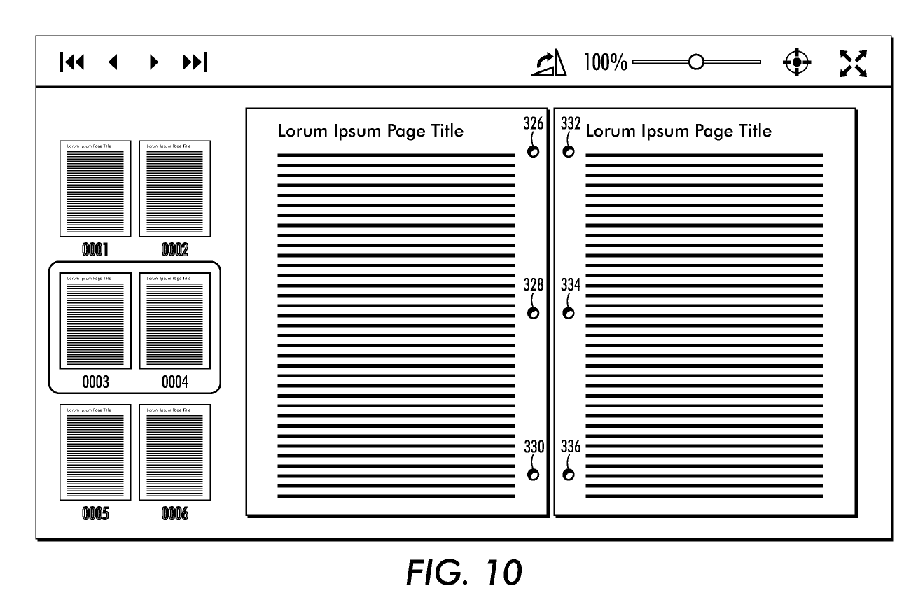

FIG. 9 shows the available hole related options 322 available to the user, which are displayed after the user clicks on “create holes” 320. As shown in FIG. 9, the user has highlighted 324 and selected a three-hole configuration aligned along the long side of the document pages. FIG. 10 is a virtual representation of the document with the selected hole configuration, including holes 326, 328, 330, 332, 334 and 336.

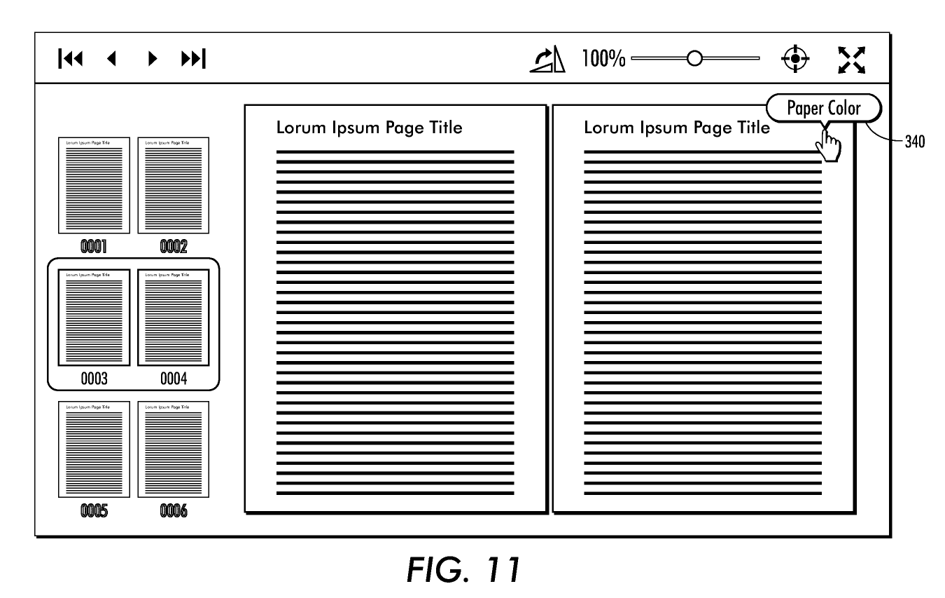

With reference to FIGS. 11-13, illustrated are the interactive virtual representation displays associated with the user configurable feature of page color. Here, as in step 228 of FIG. 3, the user places the mouse cursor substantially along the border of the page, where the interactive virtual representation displays an icon/text bar labeled “paper colors” 340, as shown in FIG. 11.

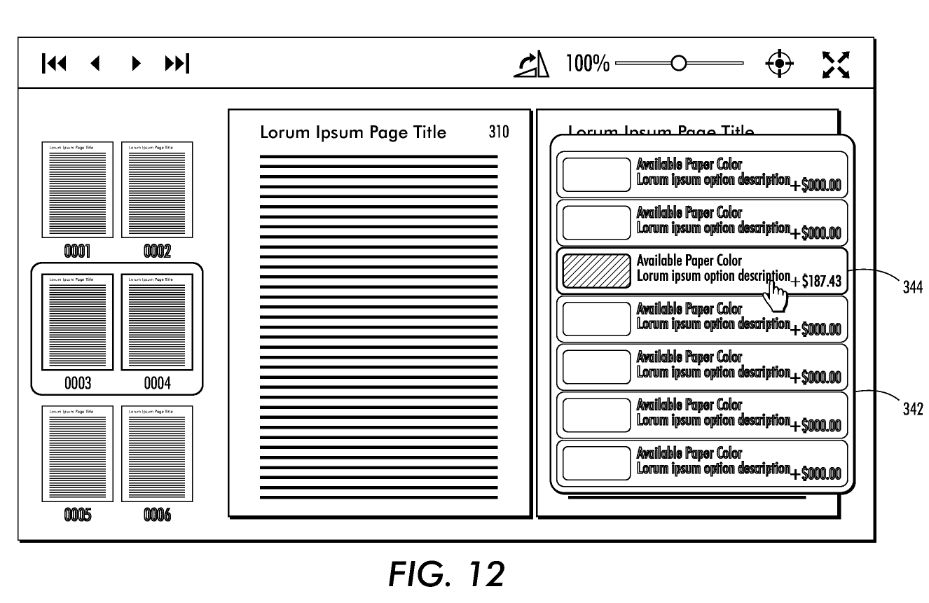

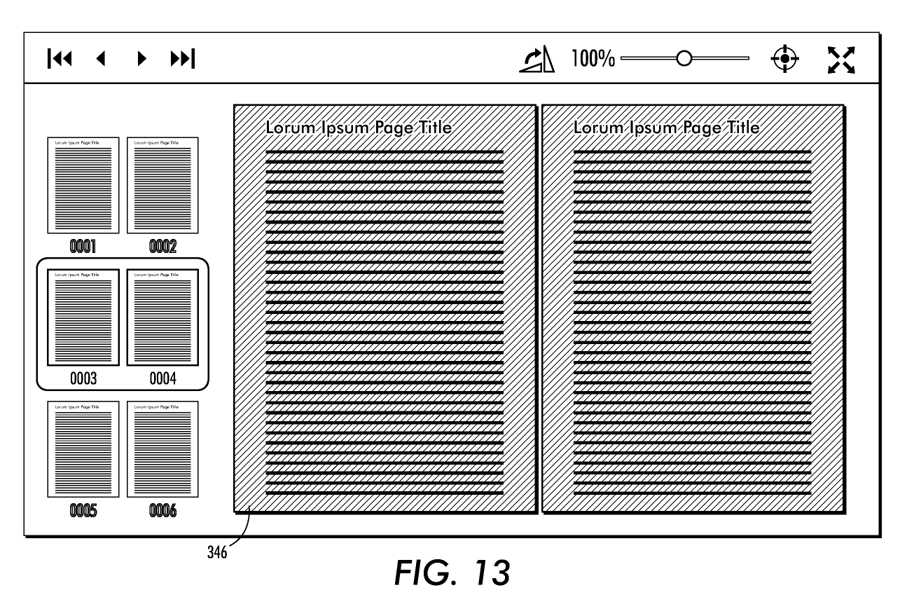

FIG. 12 shows the paper color options available to the user 342, which are displayed after the user clicks on “paper colors” 340. As shown in FIG. 12, the user has highlighted and selected a specific color 344. FIG. 13 is a virtual representation of the document 346 including the selected color.

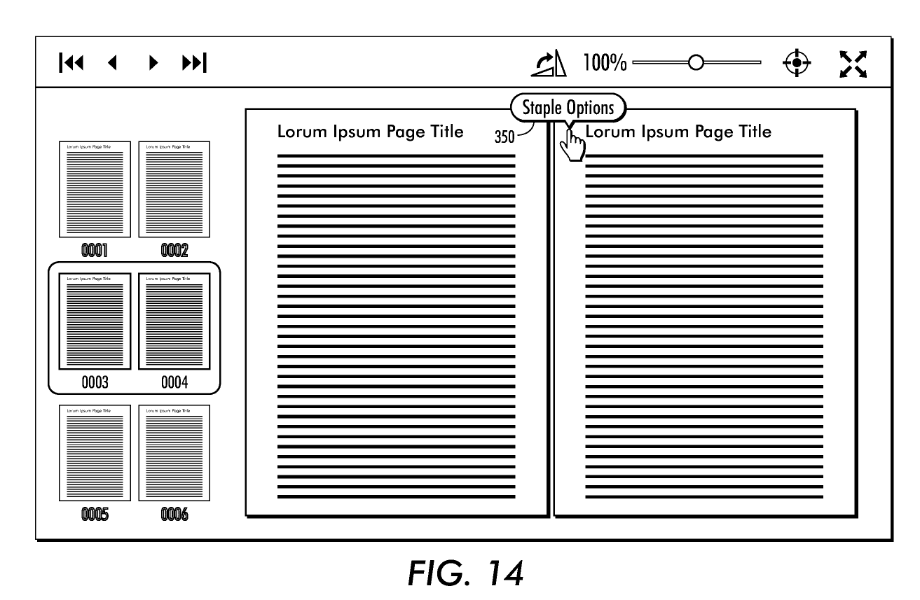

With reference to FIGS. 14-16, illustrated are the interactive virtual representation displays associated with the user configurable feature of stapling. Here, as in step 228 of FIG. 3, the user places the mouse cursor in the vicinity of where a staple is generally desired and the interactive virtual representation displays an icon/text box labeled “staple options” 350.

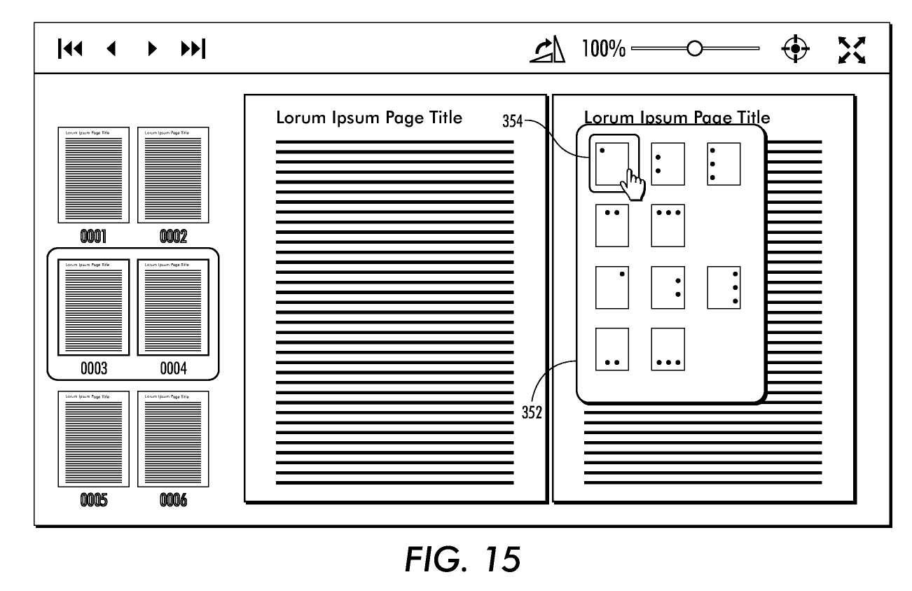

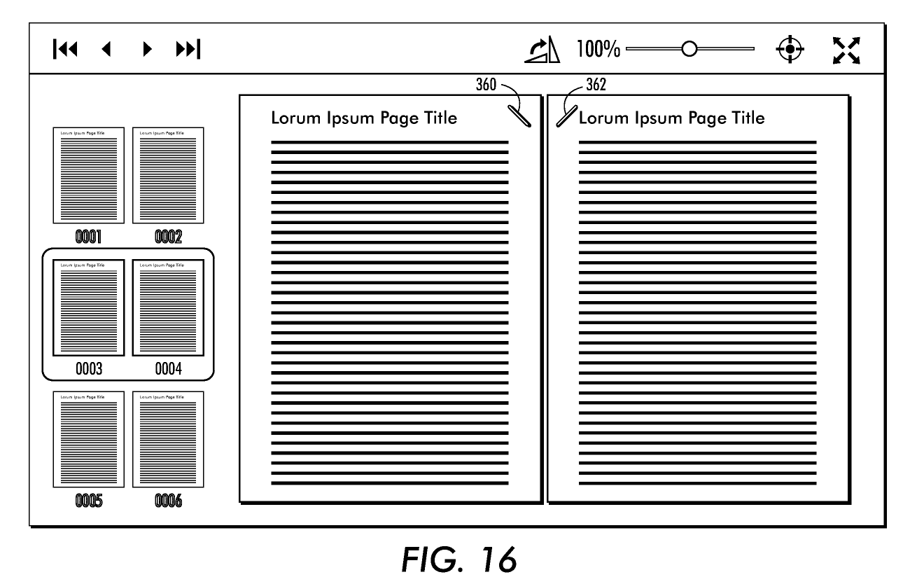

FIG. 15 shows the available staple options 352 to the user, which are displayed after the user clicks on “staple options” 350. As shown in FIG. 16, the user has highlighted and selected a particular staple location 354. FIG. 16 is a virtual representation of the document with the staple placement selected by the user, including staples 360 and 362.

In the event the user desires to move the staples 360 and 362 at this point, the user can drag the displayed staples to the desired locations.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A computer implemented interactive method for selecting job ticket options for a print job comprising:
a) a computer receiving a print job including a document including one or more pages to be printed, and an associated user configurable job ticket including user selectable job ticket options;
b) simultaneously displaying a virtual representation of one or more pages of the document associated with the print job as a finished product and an interactive user interface on a graphical user interface, the virtual representation including document borders associated with the edges of the one or more pages of the document to be printed, the interactive user interface displaying within the document borders and/or on one or more borders and/or substantially near one or more border's one or more user configurable features associated with the print job; and
c) receiving a user input associated with a configurable feature to modify the job ticket and updating the virtual representation of the print job to reflect the received user input associated with the configurable feature.

2. The method according to claim 1, wherein the user selectable job ticket options are one or more of mono, color or mixed print; collation; duplex or simplex; orientation; stapling; binding; hole punching/drilling; folding; cutting; scoring; cover media type and color; lamination; tabs; and body media type.

3. The method according to claim 1, wherein the interactive user interface is an overlay superimposed with the virtual representation of the print job.

4. The method according to claim 1, step c) receiving a user input associated with the location of the configurable feature.

5. The method according to claim 1, further comprising:
d) the computer submitting the print job to one or more print shops, the print job including a job ticket modified during the execution of steps a)-c).

6. The method according to claim 5, step d) submitting the print job to one or more print shops over the internet.

7. The method according to claim 1, wherein the interactive user interface includes a plurality of distinctive icons within the document borders and/or substantially on one or more of the document borders, the distinctive icons associated with a plurality of respective user configurable features.

8. The method according to claim 7, whereby a user positions a cursor over one of the plurality of icons to visualize a cursor text box displaying the relevant user configurable feature.

9. The method according to claim 8, whereby a user clicks on the icon to select the respective configurable feature, and a menu of options for the respective configurable feature is displayed in response to the user clicking on the icon.

10. The method according to claim 1, the virtual representation user configurable to display in one of a plurality of formats.

11. A printing system user interface comprising:
a graphical user interface configured to display a virtual representation of a print job including a document to be produced, and, simultaneously, to display an interactive user interface, the virtual representation including document borders associated with the edges of one or more pages associated with the document to be produced, the interactive user interface displaying within the document borders and/or on one or more borders and/or substantially near one or more borders, one or more user configurable features associated with the print job.

12. The printing system user interface according to claim 1, wherein the graphical user interface is configured to receive the print job and an associated user configurable job ticket including user selectable job ticket options.

13. The printing system user interface according to claim 11, wherein the graphical user interface is configured to receive a user input associated with a configurable feature to modify the job ticket, and the graphical user interface is configured to update the virtual representation of the print job to reflect the received user input associated with the configurable feature.

14. The printing system user interface according to claim 11, wherein the user configurable features are one or more of mono, color or mixed print; collation; duplex or simplex; orientation; stapling; binding; hole punching/drilling; folding; cutting; scoring; cover media type and color; lamination; tabs; and body media type.

15. The printing system user interface according to claim 11, wherein the interactive user interface is an overlay superimposed with the virtual representation of the print job.

16. The printing system user interface according to claim 11, the interactive user interface configured to receive a user input associated with the location of the configurable feature.

17. The printing system user interface according to claim 11, wherein the graphical user interface is operatively associated with a web page accessed over the internet.

18. The printing system user interface according to claim 17, wherein the graphical user interface is configured to submit the print job to a print shop.

19. The printing system interface according to claim 11, wherein the interactive user interface is configured to include a plurality of distinctive icons within the document borders and/or substantially on one or more of the document borders, the distinctive icons associated with a plurality of respective user configurable features.

20. The printing system interface according to claim 19, wherein the interactive user interface is configured to display a text box operatively associated with a user selected icon.

21. A web-based printing system comprising:
a web-based graphical user interface;
a user work station operatively connected to the web-based graphical user interface via the internet; and
a print shop operatively connected to the web-based graphical user interface,
wherein the graphical user interface is configured to communicate with the user work station, and the graphical user interface is configured to display a virtual representation of a print job including a document to be produced by the print shop, and simultaneously, to display an interactive user interface, the virtual representation including document borders associated with the edges of one or more document pages associated with the document to be produced, the interactive user interface displaying within the document's borders and/or substantially near one or more borders, one or more user configurable features associated with the print job.

22. The web-based printing system according to claim 21, wherein the graphical user interface is configured to receive the print job and an associated user configurable job ticket from the user work station, the job ticket including user selectable job ticket options.

23. The web-based printing system according to claim 21, wherein the graphical user interface is configured to receive a user input associated with a configurable feature to modify the job ticket, and the graphical user interface is configured to update the virtual representation of the print job to reflect the received user input associated with the configurable feature.

24. The web-based printing system according to claim 21, wherein the interactive user interface is configured to include a plurality of distinctive icons within the document borders and/or substantially on one or more of the document borders, the distinctive icons associated with a plurality of respective user configurable features.

25. The web-based printing system according to claim 24, wherein the interactive user interface is configured to display a text box operatively associated with a user selected icon.
